(19) United States
(12) Patent Application Publication
(10) Pub. No.: US 2015/0232026 A1
(43) Pub. Date: Aug. 20, 2015

(54) Method for Assisting a Driver at a Traffic Light for a Vehicle

(71) Applicants: Conti Temic microelectronic GmbH, Nuernberg (DE); Continental Teves AG & Co. oHG, Frankfurt (DE)

(72) Inventors: Stefan Lueke, Bad Homburg (DE); Stefan Hegemann, Wangen (DE); Matthias Komar, Frankfurt am Main (DE)

(21) Appl. No.: 14/429,208

(22) PCT Filed: Sep. 27, 2013
(86) PCT No.: PCT/DE2013/200193

§ 371 Date: Mar. 18, 2015

(30) Foreign Application Priority Data
Oct. 1, 2012 (DE) 10 2012 109 297.4

(51) Int. Cl. B60Q 9/00; G06K 9/00; B60W 40/08

(52) U.S. Cl. CPC B60Q 9/00; B60W 40/08; G06K 9/00825; G06K 9/00798; G06K 9/00315; B60W 2040/0872

(57) ABSTRACT

A method for controlling the starting of a vehicle at a traffic light by a driver assistance system is disclosed. The vehicle starts driving according to whether or not at least one traffic light is present, according to the color phase of the traffic light, and according to the driver's state of attention. A warning signal or a signal for intervening in an acceleration control process of an ego vehicle is output.

Systems for detecting traffic lights for vehicles are known.

The position and location of a traffic light can be detected, for example, with a surroundings detection sensor, in particular a camera sensor system, or can be transmitted via radio by the road sign directly or by other vehicles (c2c) to the ego vehicle.

Furthermore, systems for detecting the driver's state of attention with a camera sensor system in the interior of a vehicle are known from the prior art.

It is the object of this invention to disclose a method for assisting a driver at a traffic light.

This object is achieved with the features of the independent claims.

One essential concept of the invention is to assist an inattentive driver in a traffic light situation, in particular to prevent unwanted starting at a traffic light.

The method is used in a driver assistance system which specifies means for detecting at least one traffic light and the color phase of the traffic light. In particular, a camera sensor system or a radio receiver for receiving radio signals from other vehicles (c2c communication) or radio signals directly from road signs is provided for this purpose. In addition, the driver assistance system comprises means for detecting the driver's state of attention. The driver's state of attention can be detected, for example, with a camera system in the interior of the vehicle. The camera system can also detect the driver's line of sight and can therefore, for example, establish whether or not the latter has the traffic light in his field of vision. In addition, conclusions can be made about the driver's state of attention by means of hands-off detection or by monitoring the driver's activities on the multimedia systems provided in the vehicle (e.g. surfing the internet). The driver assistance system also comprises a control unit. If an inattentive driver is detected, depending on the color phase of the traffic light, the control unit outputs a warning signal. Means are therefore provided for providing a visual, audible or haptic warning to the driver. Alternatively or in addition, an intervention is made in a longitudinal dynamics control process of the ego vehicle.

In a preferred embodiment of the invention the surroundings of a vehicle are detected with means for detecting the surroundings. Means for detecting the surroundings are e.g. radar, lidar, camera or navigation systems or radio communication systems with other road users (c2c) or a combination of at least two of the above. The means for detecting traffic lights and the means for detecting the surroundings are preferably configured as a camera system. The position or location of lanes and/or road signs with respect to the ego vehicle is detected with the means for detecting the surroundings. Based on this, the relevance of the traffic light to the ego vehicle is determined. For example, a distant traffic light, the range of validity of which has not yet been reached by the ego vehicle, is not relevant. In particular, in the case of those traffic lights (traffic lights for vehicles turning left or right) or road signs (green arrow for vehicles turning right) where their validity can depend on the lane, the determination of the relevance of the traffic light depending on the lane is also important.

In a positive embodiment of the invention the relevance of the traffic light is determined according to a probable route of the ego vehicle. The probable route is, for example, detected by an activated direction indicator or a calculated route of a navigation device.

This approach is advantageous in the case of traffic lights for vehicles turning left or right or road signs which only apply to a certain direction of travel (green arrow for vehicles turning right).

In a positive embodiment of the invention a traffic light position is assigned to a probable route. In particular, a traffic light position is assigned, if there are multiple lanes with a direction indication (e.g. vehicles turning right, vehicles travelling straight on, vehicles turning left). The presence of lanes with a direction indication can, for example, be detected by means of arrows marked on the roadway of a lane with a camera system or with a navigation system. The assigned traffic light position can be above, to the left of or to the right of the lane. A warning signal is output, if the driver was not looking in the direction of the assigned traffic light position before passing the traffic light.

In a preferred embodiment of the invention a right turning lane is detected by means of arrows marked on the roadway of a lane with a camera system or with a navigation system. On driving into this right turning lane a warning signal is output, if the driver was not looking to the right before passing the traffic light, where a traffic light for vehicles turning right or a road sign which applies to vehicles turning right is typically located, for example, a green arrow for vehicles turning right.

The exact position of the traffic light or road sign can also be detected with a surroundings detection sensor system (e.g. camera system) and then compared with the line of sight.

In a preferred embodiment of the invention the signal for intervening in the longitudinal dynamics control process is configured in such a way that a current acceleration of the ego vehicle is increased or attenuated or the ego vehicle is prevented from starting.

If the driver wishes to move off, e.g. despite the traffic light being red, the vehicle is prevented from starting.

In a preferred embodiment of the invention the vehicle is only started at a traffic light, in the event that the ego vehicle was prevented from starting, following clearance by the driver. This clearance is provided, in particular, by detecting an operation of an accelerator pedal, wherein the deflection of the accelerator pedal and/or the operating speed must exceed a threshold value (e.g. kickdown).

1. A method for controlling the starting of a vehicle at a traffic light by a driver assistance system, which comprises
means for detecting at least one traffic light and the color phase of the traffic light, in particular a camera sensor system, and
means for detecting the driver's state of attention and
an evaluation or control unit connected to the means, wherein, in the event of an inattentive driver, the evaluation or control unit outputs a warning signal or a signal for intervening in a longitudinal control process of an ego vehicle according to whether or not at least one traffic light is present and according to the color phase of the traffic light.

2. The method according to claim 1, characterized in that the driver's state of attention is determined based on the driver's line of sight, preferably based on the data from a camera system in the interior of the ego vehicle.

3. The method according to claim 1, characterized in that surrounding objects are detected with means for detecting the surroundings and the position or location of lanes and/or road signs with respect to the ego vehicle are established and the relevance of the traffic light to the ego vehicle is determined.

4. The method according to claim 3, characterized in that the relevance of the traffic light is established according to a probable route of the ego vehicle.

5. The method according to claim 4, characterized in that the probable route is detected based on an activated direction indicator or a calculated route of a navigation device or a camera sensor system for detecting arrows marked on the roadway of a lane.

6. The method according to claim 2, characterized in that a traffic light position above, to the left of or to the right of the lane is assigned to a probable route of the vehicle and a warning signal is output, if the driver was not looking at the assigned traffic light position before passing the traffic light.

7. The method according to claim 2, characterized in that a right turning lane is detected from arrows marked on the roadway of a lane with a camera system or with a navigation system and on driving into this right turning lane a warning signal is output, if the driver was not looking to the right before passing the traffic light.

8. The method according to claim 1, characterized in that the signal for intervening in a longitudinal control process is configured in such a way that a current acceleration of the ego vehicle is increased or attenuated.

9. The method according to claim 1, characterized in that the signal for intervening in a longitudinal control process is configured in such a way that the ego vehicle is prevented from starting.

10. The method according to claim 9, characterized in that the ego vehicle starts driving following clearance from a driver, wherein the clearance is detected in particular by detecting the operation of an accelerator pedal above a threshold.

11. A driver assistance system for performing the method according to claim 1, comprising
means for detecting at least one traffic light and the color phase of the traffic light,
means for detecting the driver's state of attention, and
an evaluation or control unit connected to the means and having an electronic memory, in which a program configured and adapted to perform the method is stored.

12. A method of controlling the starting of a subject vehicle at a traffic light by a driver assistance system of the subject vehicle, which method comprises
with a camera of the driver assistance system, detecting a traffic light and a color phase of the traffic light,
with a sensor of the driver assistance system, detecting a state of attention of a driver of the vehicle, and
with an evaluation or control unit of the driver assistance system, evaluating outputs from the camera and the sensor, and when the state of attention of the driver indicates that the driver is inattentive and the traffic light has been detected, then dependent on the color phase of the traffic light outputting at least one of a warning signal to warn the driver and a control signal to affect a longitudinal control of the subject vehicle.

13. A driver assistance system for a vehicle, comprising:
a camera system configured and arranged to detect a traffic light and a color phase of the traffic light in an environment around the vehicle;
a sensor configured and arranged to detect a driver's state of attention of a driver of the vehicle; and
an evaluation or control unit that is connected to outputs of the camera system and the sensor, and that includes a memory in which is stored a program, which when executed, triggers at least one of a warning signal to warn the driver and a control signal to control longitudinal motion of the vehicle, depending on the detection of the traffic light, the color phase of the traffic light, and the driver's state of attention.
